(19) United States
(12) Patent Application Publication
(10) Pub. No.: US 2003/0127771 A1
(43) Pub. Date: Jul. 10, 2003

(54) Method of manufacturing pillar gel candles

(76) Inventor: Robert J. Schinski, Renton, WA (US)

Correspondence Address: Dean A. Craine, DEAN A. CRAINE, P.S., Suite 140, 400 112th Avenue NE, Bellevue, WA, 98004-5542, US

(21) Appl. No.: 10/039,213

(22) Filed: Jan. 4, 2002

(51) Int. Cl. B29C 33/40

(52) U.S. Cl. 264/219; 264/330

(57) ABSTRACT

A method of manufacturing a pillar gel candle that produces a crystal clear, freestanding, pillar-style gel candle. The steps of the method include assembling the mold, manufacturing a gel candle composition suitable for making a pillar gel candle, pouring the gel candle composition into the assembled mold, allowing the gel candle composition to set, and disassembling the mold. The mold is made of a plurality of side member components which form a central polyhedron-shaped void in which the heated gel candle composition is poured. Each side member component has a smooth, polished, inside surface to produce a pillar gel candle with smooth, glass-like appearing surfaces.

### BACKGROUND OF THE INVENTION

1. Field of the Invention

This invention pertains to methods of manufacturing candles, and more specifically, to methods of manufacturing pillar gel candles.

2. Description of the Related Art

Recently, gel candles made of highly refined, high viscosity hydrocarbons oils have become popular. Some of the main advantages of gel candles are their easy manufacturing, long life and low soot production. A leading company in this technology is Penreco Company, located in Houston, Tex. which has obtained a U.S. Patent (U.S. Pat. No. 5,879,694) for a novel, transparent gel candle composition. The gel candle composition uses a hydrocarbon oil and at least one co-polymer selected from a group consisting of a triblock polymer, a radial block copolymer, a multiblock copolymer, and an optional diblock polymer that produces a firm candle with suitable rheological properties.

In the Inventor's co-pending U.S. patent application (Ser. No. 09/998,436 filed Nov. 30, 2001), an improved gel candle composition is disclosed that uses three different viscosity mineral oils and a polymer to produce a container-less or free-standing (a.k.a. pillar) gel candle. Because the mineral oils are clear, the gel candle appears to be made out of glass, or similar crystallized materials. Unfortunately, because the gel candle is tacky, standard candle molds and molding techniques cannot be followed.

### SUMMARY OF THE INVENTION

It is an object of the present invention to provide a method of manufacturing a freestanding pillar gel candle.

It is another object of the present invention to produce such a gel candle with smooth, glass-like, surfaces.

These and other objects are met by a method of manufacturing a free-standing pillar gel candle disclosed herein that uses the following steps: (1) selecting a pillar candle mold capable of being assembled and disassembled from a pillar candle, said mold being open on at least one end and having smooth, non-porous inside surfaces; (2) assembling the mold in a vertical position on a flat surface; (3) manufacturing a clear gel candle composition capable of being used to produce a free-standing pillar candle; (4) heating the gel candle composition to a liquid state; (5) pouring the heated gel candle composition into the assembled mold; (5) allowing the gel candle composition to cool; and (6) disassembling the mold to produce a free-standing pillar candle.

In the preferred embodiment, the mold forms a free-standing, polyhedron-shaped gel candle with a plurality of planar side surfaces. The mold is made of a plurality of side wall components that are vertically aligned and forced together to form a mold with a polyhedron-shaped central void in which the melted gel candle composition may be poured. The mold has top and bottom openings so that it may be easily broken down and pulled away from the gel candle when cool. A temporary holding means, such as an elastic strap, is used to temporarily hold the side wall components together. In the preferred method, the mold is assembled on a ceramic tile base. All of the side wall components have polished, non-porous contact surfaces such as those found on metal, glass or ceramic to produce smooth, glass-like surfaces that enhance the overall beauty of the gel candle.

### DESCRIPTION OF THE DRAWINGS

FIG. 1 is a perspective view of the mold assembled on a ceramic surface.

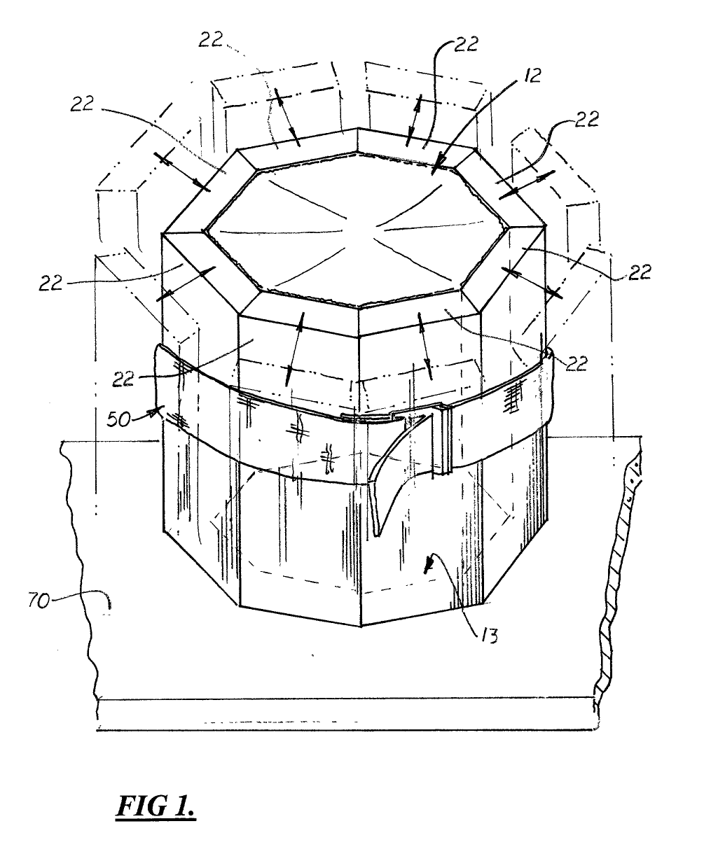

FIG. 2 is a side elevation view of the mold.

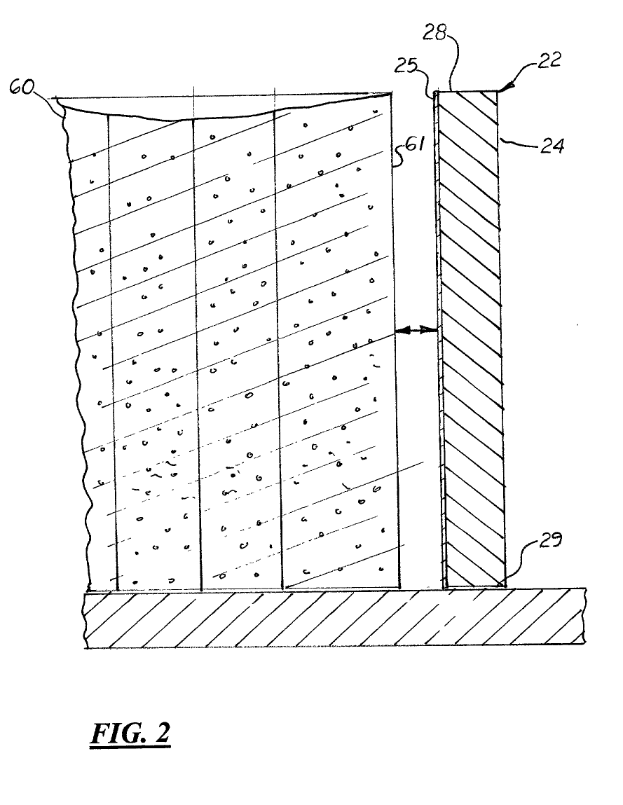

FIG. 3 is a top plan view of the mold.

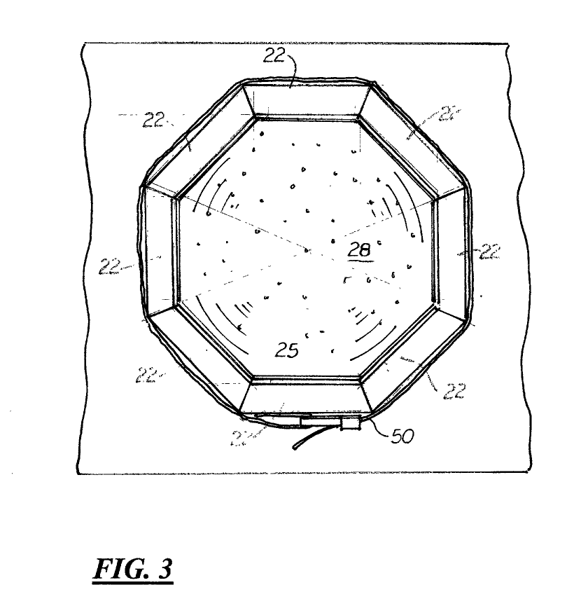

FIG. 4 is a flow chart of the steps used to manufacture the gel candle.

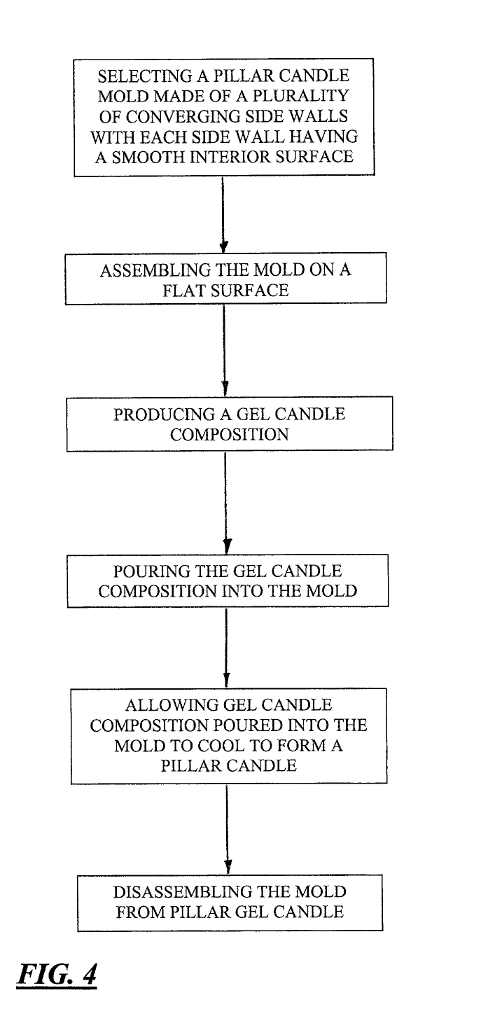

### DESCRIPTION OF THE PREFERRED EMBODIMENT(S)

Disclosed herein is a method of manufacturing a pillar gel candle 60 with smooth, glass-like side walls. The method begins by assembling a mold 10 in which the molten gel candle composition 20 is poured. In the preferred embodiment, the mold 10 comprises a set of converging side wall components 22 aligned perpendicular over a flat base member 30 to form a polyhedron-shaped mold 10 with top and bottom openings 12, 13, respectively. Each converging side wall component 22 includes a curved outside surface 24, a curved inside surface 25, two converging side surfaces 26, 27, and parallel, flat, top and bottom surfaces 28, 29. When assembled, the side surfaces 26, 27 of adjacent converging side wall components 22 are forced and held together using an adjustable or elastic strap 50, rubber bands or other suitable means to create a closed enclosure with sufficiently closed seams between the adjacent side wall components 22 so that the heated gel candle composition 20 will not seep through. The side wall components 22 are made of any suitable rigid material with highly polished and non-porous inside surfaces 25. In the preferred embodiment, the inside surface 25 comprises a stainless steel plate adhesively attached to the side wall component 22. When the gel candle 60 is molded, the polished, non-porous inside surface 25 produces a smooth, glass-like finish on each planar surface 61 of the gel candle 60. In the preferred embodiment, the mold 10 is assembled on a ceramic tile 70 so that the gel candle composition 20 slowly and evenly cools.

In the preferred embodiment shown in the Figs., the mold 10 includes eight identical side wall components 22 that produce a hexagonal pillar gel candle 60.

After the mold 10 is assembled, the gel candle composition 20, disclosed in the Inventor's co-pending U.S. patent application (Ser. No. 09/998,436) and incorporated herein, is prepared. The gel candle composition 20 is made of a high viscosity first mineral oil, a second mineral oil, and a third mineral oil, all mixed together with a thermoplastic polymer to produce a heterophase thermally reversible mineral oil gel. The first mineral oil used (58% to 81% wt.)to manufacture the gel candle composition 20 is a medium range viscosity (106.5-125.5 cSt.) such as the mineral oil product manufactured and sold by Penreco Company under the trademark DRAKEOL-600. The second mineral oil used (8-9%) is a higher viscosity (180-240 cSt) mineral oil produce manufactured and sold by Witco Company and sold under the trademark HYDROBRITE-1000. The third mineral oil used (2 to 6% wt) is a lower viscosity mineral oil (72-79.5 cSt.) is a mineral oil product manufactured and sold by Penreco Company under the trademark DRAKEOL 34. The stabilizing polymer is a thermoplastic polymer manufactured and sold by Kraton Polymers (12% to 16% wt.) located in Belpre, Ohio (USA).

During manufacture, the three mineral oils and polymer are mixed together in a suitable mixing container. The mixture is then allowed to sit overnight, allowing the oil to soak into the polymer to create a homogenous product. The mixture is then poured into cylindrical stainless steel heating tanks that have heating elements affixed to their bottom and sides. Reject gel candles from previous batches may be added to the mixture which is then heated for 16-24 hours to a temperature of 335-345 degrees Fahrenheit. Scent and dye are added just before pouring.

Each mold is positioned in an upright, vertical position on a ceramic tile 70. The mold 10 is then filled using a valve mounted to the side of the heating tank. The mold 10 is positioned under the valve and the valve is slowly opened so that the melted gel candle composition 20 flows into the top opening 12 and completely fills the central void 15 in the mold 10. As the melted gel candle composition 20 flows into the central void 15, the user inserts a steel rod about the size of a knitting needle into the flow to interrupt the stream thus minimizing the air bubbles. The mold 10 is filled to the top surface 28 and the valve is shut. If desired, another mold 10 is placed under the valve to repeat the process.

The filled mold 10 is then inspected and a heat gun may be used to pop any air bubbles that may have been created in the gel candle composition 20 and floated to the top. If air bubbles are created that stick to the side of the mold 10, a thin rod may be inserted to dislodge the air bubble and pull it to the surface so it may be popped.

Additional molds may be continuously filled until the heating tank is empty. The heating tank is refilled with another batch. The molds 10 are allowed to cool for approximately 8 hours.

After the molds 10 have cooled, each candle 60 is then threaded with a wick using a simple jig to vertically align the needle in the center of the pillar gel candle 60. The wick is then trimmed to the correct length. The adjustable strap 50 is then removed and the mold 10 is then broken down and removed from the pillar gel candle 60. The pillar gel candle 60 is then trimmed if necessary and then packaged into its container. The mold 10 can then be reassembled for manufacturing other pillar gel candles. When finished, the pillar gel candle 60 is a polyhedron-shaped pillar candle with smooth, glass-like planar side surfaces. The bottom surface 29 is flat while the top surface 28 is slightly concave.

In compliance with the statute, the invention described herein has been described in language more or less specific as to structural features. It should be understood, however, that the invention is not limited to the specific features shown, since the means and construction shown, is comprised only of the preferred embodiments for putting the invention into effect. The invention is therefore claimed in any of its forms or modifications within the legitimate and valid scope of the amended claims, appropriately interpreted in accordance with the doctrine of equivalents.

I claim:

1. A method of manufacturing pillar gel candles, comprising the following steps:
a. selecting a mold made of a plurality of side walls that form a central void, said mold having a top opening;
b. assembling the mold or a support surface;
c. producing a liquid gel candle composition;
d. pouring said liquid gel candle composition into said central void of said mold;
e. allowing said gel candle composition to cool to form a pillar gel candle; and,
f. disassembling said side wall of said mold from said pillar gel candle.

2. The method of manufacturing a pillar gel candle as recited in claim 1, wherein the gel candle composition includes:
a. a first mineral oil having a viscosity in a range of 106.5 to 125.5 (cSt) and in the amount between 58% to 81% by weight;
b. a second mineral oil having a viscosity in a range of 180 to 240 (cSt) and in the amount of 5% to 20% by weight;
c. a third mineral oil having a viscosity in a range of 72 to 79.5 (cSt) and in the amount of 2% to 6% by weight; and,
d. a stabilizing polymer in a range of 12% to 16% by weight.

3. The method of manufacturing a pillar gel candle as recited in claim 1, wherein each said side wall has a smooth, non-porous inside surface.

4. The method of manufacturing a pillar gel candle as recited in claim 1, wherein said inside surface is made of stainless steel.

5. The method of manufacturing a pillar gel candle as recited in claim 3, wherein said mold side walls are made of glass.

6. The method of manufacturing a pillar gel candle as recited in claim 1, wherein said mold includes a bottom opening.

7. The method of manufacturing a pillar gel candle as recited in claim 1, wherein there are eight side walls thereby forming an eight-sided polyhedron.
